(19) United States
(12) Patent Application Publication
(10) Pub. No.: US 2015/0258639 A1
(43) Pub. Date: Sep. 17, 2015

(54) Mixed Oxide Materials for Helium Leak Tight, Oxidation Resistant and High Strength Joints Between High Temperature Engineering Materials

(71) Applicants: Frederick M. Mako, JR., Fairfax Station, VA (US); Edward Jeffrey Cruz, Sterling, VA (US); Frederick M. Mako, Fairfax Station, VA (US)

(72) Inventors: Frederick M. Mako, JR., Fairfax Station, VA (US); Edward Jeffrey Cruz, Sterling, VA (US); Frederick M. Mako, Fairfax Station, VA (US)

(73) Assignee: Frederick M. Mako, Fairfax Station, VA (US)

(21) Appl. No.: 14/671,361

(22) Filed: Mar. 27, 2015

Related U.S. Application Data
(63) Continuation-in-part of application No. 14/656,253, filed on Mar. 12, 2015.
(60) Provisional application No. 61/952,492, filed on Mar. 13, 2014.
(60) Provisional application No. 61/971,941, filed on Mar. 28, 2014.
(60) Provisional application No. 61/972,582, filed on Mar. 31, 2014.
(60) Provisional application No. 61/972,630, filed on Mar. 31, 2014.
(60) Provisional application No. 61/973,027, filed on Mar. 31, 2014.
(60) Provisional application No. 61/973,085, filed on Mar. 31, 2014.
(60) Provisional application No. 61/971,941, filed on Mar. 28, 2014.
(60) Provisional application No. 61/972,582, filed on Mar. 31, 2014.
(60) Provisional application No. 61/972,630, filed on Mar. 31, 2014.
(60) Provisional application No. 61/973,027, filed on Mar. 31, 2014.
(60) Provisional application No. 61/973,085, filed on Mar. 31, 2014.

(51) Int. Cl. B23K 35/36; C03C 8/24

(52) U.S. Cl. CPC B23K 35/3607; B23K 35/361; C03C 8/24; C03C 2204/00

(57) ABSTRACT

A high strength joint material. A material for a joint between a ceramic body and a metal body. A material for a joint between a ceramic body and a ceramic body.

### CROSS-REFERENCE TO RELATED APPLICATIONS

This is a continuation-in-part of U.S. patent application Ser. No. 14/656,253 filed Mar. 12, 2015, and is a nonprovisional of U.S. provisional application Ser. Nos. 61/971,941 filed Mar. 28, 2014; 61/972,582 filed Mar. 31, 2014; 61/972,630 filed Mar. 31, 2014; 61/973,027 filed Mar. 31, 2014; and 61/973,085 filed Mar. 31, 2014, all of which are incorporated by reference herein.

### FIELD OF THE INVENTION

The present invention is related to a material for a joint between a ceramic body and a ceramic body or a metal body. (As used herein, references to the “present invention” or “invention” relate to exemplary embodiments and not necessarily to every embodiment encompassed by the appended claims.) More specifically, the present invention is related to a material for a joint between a ceramic body and a ceramic body or a metal body that has combinations of the following: alumina or magnesia or aluminum-silicate or magnesium-silicate.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

High temperature (800° C. to 1450° C.) engineering materials, such as silicon carbide, mullite or tungsten, have many desirable properties, but are often difficult to manufacture in large sizes or complex geometries. These materials are also very difficult to join and hermetically seal with existing technologies in such a way so as to be still suitable for desired high temperature applications with high strength. The ability to employ materials that can withstand higher temperature than what the current state of the art offers can often have tremendous benefits, such as increased production volume from ethylene plants and increased safety margins for nuclear reactors. The present invention allows extended application of these high temperature materials by allowing for them to be joined such that the joining material does not negatively affect the high temperature performance of the bulk materials, including, but not limited to, when the joining material is subject to a high temperature environment.

### BRIEF SUMMARY OF THE INVENTION

The subject invention relates to the formulation of a family of mixed oxide materials for joining bodies of ceramic and/or metals, specifically: silicon carbide, mullite or tungsten to silicon carbide, mullite or tungsten. The joints produced using these materials are able to withstand high temperatures while maintaining a high degree of strength comparable to the as received materials that were joined.

The present invention pertains to a high strength joint material consisting essentially of alumina (99.8% purity), silica (99.99% purity) and magnesia (99+% purity) with or without additions collectively of less than 4 wt % of TiO2, Fe2O3, CaO, NaO2, K2O, P2O5 and sintering aid materials.

The present invention pertains to a mixture for a joint between a ceramic body and a metal body. The mixture comprises between 30 wt % (weight percent or percent by mass) and 80 wt %, nominally 60 wt %, aluminum-silicate, and between 20 wt % and 70 wt %, nominally 40 wt %, magnesium-silicate.

The present invention pertains to a method for making a mixture comprised of between 30 wt % (weight percent or percent by mass) and 80 wt %, nominally 60 wt %, aluminum-silicate, and between 20 wt % and 70 wt %, nominally 40 wt %, magnesium-silicate.

The present invention pertains to a mixture for a joint between a ceramic body and a metal body. The mixture comprises between 16.8 wt % and 35.8 wt %, nominally 28.2 wt %, alumina, between 57.9 wt % and 61.2 wt %, nominally 59.2 wt %, silica and between 6.3 wt % and 22.0 wt %, nominally 12.6 wt %, magnesia.

The present invention pertains to a method for making a mixture comprised of between 16.8 wt % and 35.8 wt %, nominally 28.2 wt %, alumina, between 57.9 wt % and 61.2 wt %, nominally 59.2 wt %, silica and between 6.3 wt % and 22.0 wt %, nominally 12.6 wt %, magnesia.

The present invention pertains to a mixture for a joint between a ceramic body and a ceramic body. The mixture comprises between 30 wt % (weight percent or percent by mass) and 80 wt %, nominally 60 wt %, aluminum-silicate, and between 20 wt % and 70 wt %, magnesium-silicate.

The present invention pertains to a method for making a mixture comprised of between 30 wt % (weight percent or percent by mass) and 80 wt %, nominally 60 wt %, aluminum-silicate, and between 20 wt % and 70 wt %, magnesium-silicate.

The present invention pertains to a mixture for a joint between a ceramic body and a ceramic body. The mixture comprises between 16.8 wt % and 35.8 wt % alumina, between 57.9 wt % and 61.2 wt % silica and between 6.3 wt % and 22.0 wt % magnesia.

The present invention pertains to a method for making a mixture comprised of between 16.8 wt % and 35.8 wt % alumina, between 57.9 wt % and 61.2 wt % silica and between 6.3 wt % and 22.0 wt % magnesia.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a cross-sectional view of a collar around ceramic bodies.

FIG. 2 is a cross-sectional view of a collar with a greater taper angle and ceramic bodies with a lesser taper angle.

FIG. 3a is a perspective view of a large diameter to small diameter lap joint.

FIG. 3b is a perspective view of an elbow bend joint.

FIG. 3c is a perspective view of U bend joint.

FIG. 3d is a perspective view of a Y bend joint.

FIG. 4a is a perspective view of a large pipe connected to smaller pipes.

FIG. 4b is a perspective view of a corner.

FIG. 5 is a representation of a joint.

FIG. 6 is a representation of a taper joint.

FIG. 7 is a representation of a step joint.

FIG. 8 is a representation of a groove joint.

FIG. 9 is a representation of a plug joint.

FIG. 10 is a representation of a ceramic to metal joint example.

### DETAILED DESCRIPTION OF THE INVENTION

Referring now to the drawings wherein like reference numerals refer to similar or identical parts throughout the several views, and more specifically to figure thereof, there is shown a high strength joint material consisting essentially of alumina (99.8% purity), silica (99.99% purity) and magnesia (99+% purity) with or without additions collectively of less than 4 wt % of TiO2, Fe2O3, CaO, NaO2, K2O, P2O5 and sintering aid materials.

The high strength joint material may further comprise a mixed oxide material selected from the group consisting of Magnesium Silicate and Aluminum Silicate. The high strength joint material may further comprise a mixed oxide material selected from the group consisting of Steatite® and Mulcoa®. The high strength joint material may further comprise a mixed oxide material selected from the group consisting of Steatite® and Lava. The high strength joint material may further comprise a mixed oxide material selected from the group consisting of Steatite® and Wonder Stone®.

The joint material may provide oxidation resistance at a temperature between 400° C. and 1500° C. The joint material may join one of ceramic-to-ceramic, ceramic-to-metal and metal-to-metal. The joint material may have a coefficient of thermal expansion between 1.5×10−6/K and 5×10−6/K at a room temperature.

The joint material may form a hermetic joint between similar or dissimilar materials when the similar or dissimilar materials to be joined have a coefficient of thermal expansion between 1.5×10-6/K and 5×10−6/K, wherein the hermetic joint is defined by an ability to seal to less than 1×10-9 torr.-L./sec. helium leak rate. The hermetic joint between the dissimilar materials with a coefficient of thermal expansion mismatch when each of the dissimilar materials to be joined may have a coefficient of thermal expansion between 1.5×10-5/K and 5×10-6/K.

The present invention pertains to a mixture for a joint between a ceramic body and a metal body. The mixture comprises or consists essentially of between 30 wt % (weight percent or percent by mass) and 80 wt %, nominally 60 wt %, aluminum-silicate, and between 20 wt % and 70 wt %, nominally 40 wt %, magnesium-silicate.

The present invention pertains to a method for making a mixture comprised of or consisting essentially of between 30 wt % (weight percent or percent by mass) and 80 wt %, nominally 60 wt %, aluminum-silicate, and between 20 wt % and 70 wt %, nominally 40 wt %, magnesium-silicate.

The present invention pertains to a mixture for a joint between a ceramic body and a metal body. The mixture comprises or consists essentially of between 16.8 wt % and 35.8 wt %, nominally 28.2 wt %, alumina, between 57.9 wt % and 61.2 wt %, nominally 59.2 wt %, silica and between 6.3 wt % and 22.0 wt %, nominally 12.6 wt %, magnesia.

The present invention pertains to a method for making a mixture comprised of or consisting essentially of between 16.8 wt % and 35.8 wt %, nominally 28.2 wt %, alumina, between 57.9 wt % and 61.2 wt %, nominally 59.2 wt %, silica and between 6.3 wt % and 22.0 wt %, nominally 12.6 wt %, magnesia.

The present invention pertains to a mixture for a joint between a ceramic body and a ceramic body. The mixture comprises or consists essentially of between 30 wt % (weight percent or percent by mass) and 80 wt %, nominally 60 wt %, aluminum-silicate, and between 20 wt % and 70 wt %, magnesium-silicate.

The present invention pertains to a method for making a mixture comprised of or consisting essentially of between 30 wt % (weight percent or percent by mass) and 80 wt %, nominally 60 wt %, aluminum-silicate, and between 20 wt % and 70 wt %, magnesium-silicate.

The present invention pertains to a mixture for a joint between a ceramic body and a ceramic body. The mixture comprises or consists essentially of between 16.8 wt % and 35.8 wt % alumina, between 57.9 wt % and 61.2 wt % silica and between 6.3 wt % and 22.0 wt % magnesia.

The present invention pertains to a method for making a mixture comprised of or consisting essentially of between 16.8 wt % and 35.8 wt % alumina, between 57.9 wt % and 61.2 wt % silica and between 6.3 wt % and 22.0 wt % magnesia.

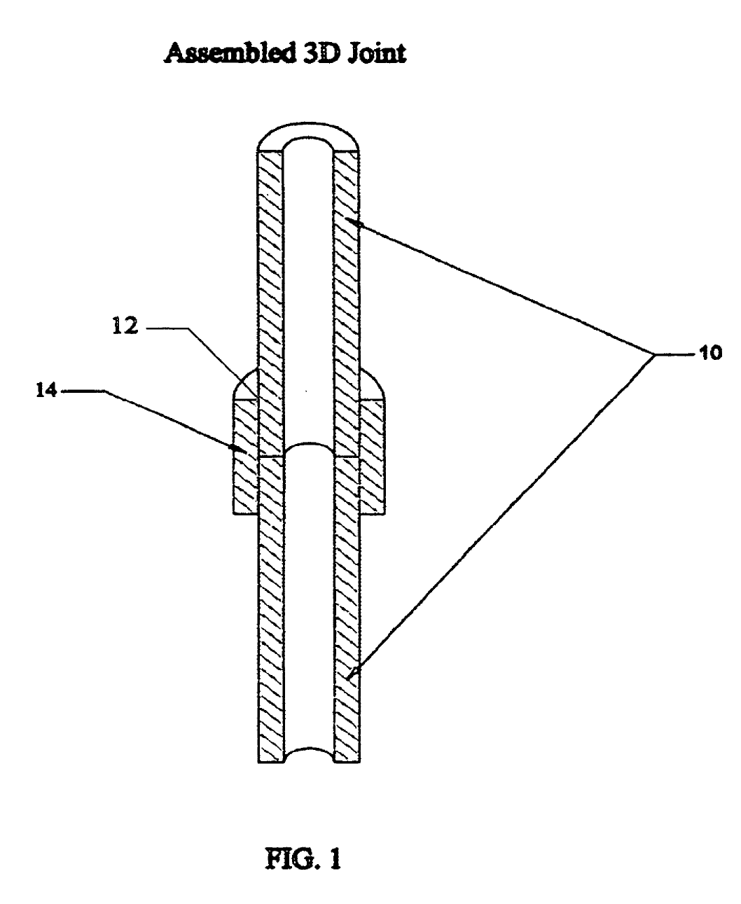

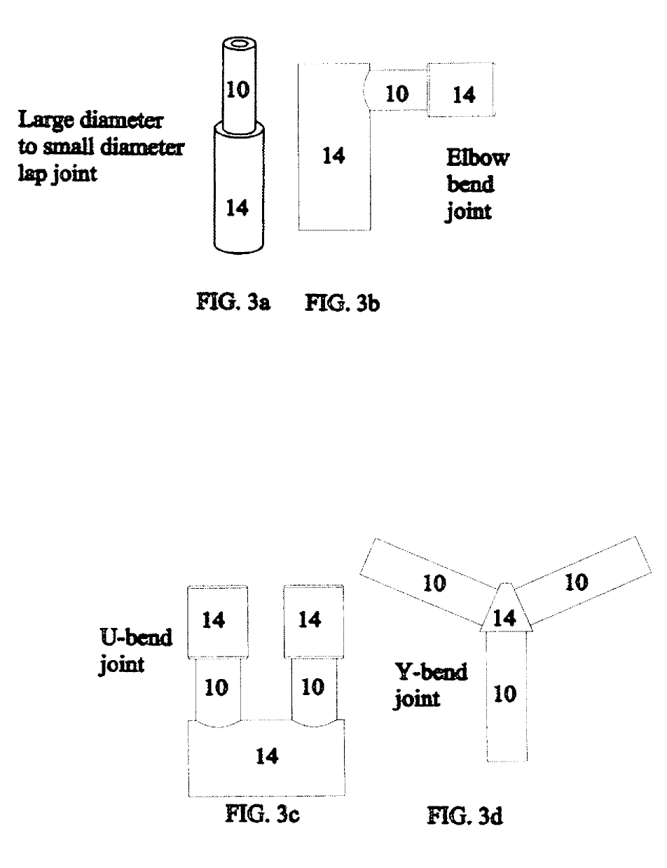

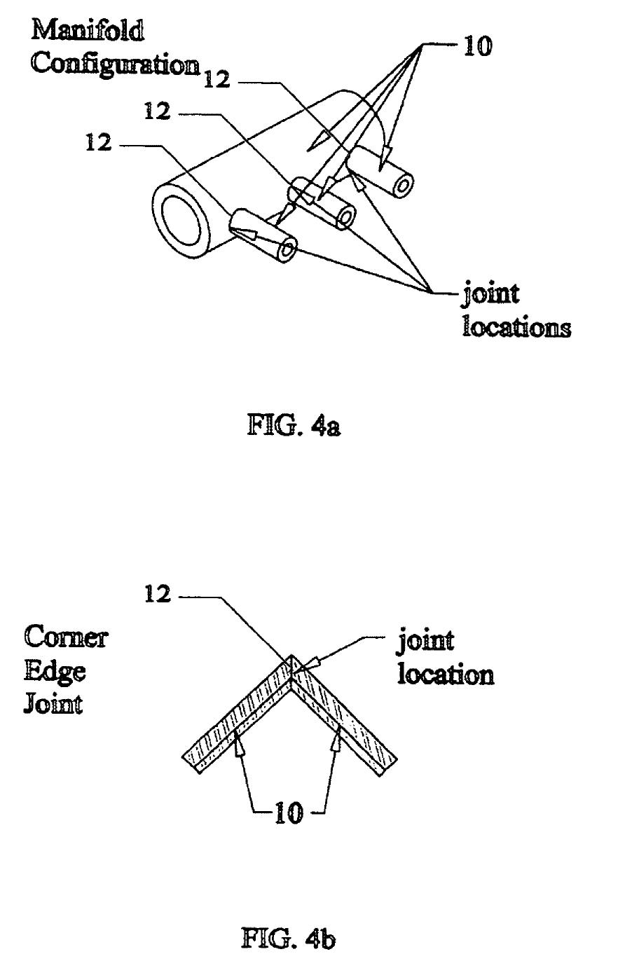

A family of mixed oxide materials, henceforth referred to as Makotite™ or Makotite™ joining material, designed for the purpose of joining ceramic and metal bodies for use at high service temperatures of 400° C. to 1500° C. The forms of ceramic and metal bodies 10, specifically: silicon carbide 1, mullite 2 or tungsten 3 bodies capable of being joined by the described material include shapes, such as, plate, rod, ball, tube, and others. These bodies 10 may be joined to either similar or dissimilar silicon carbide, mullite or tungsten shapes. (FIGS. 1-5.)

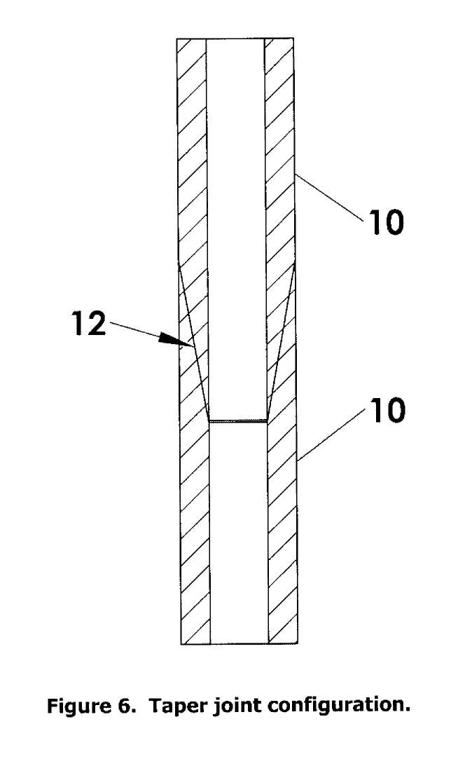

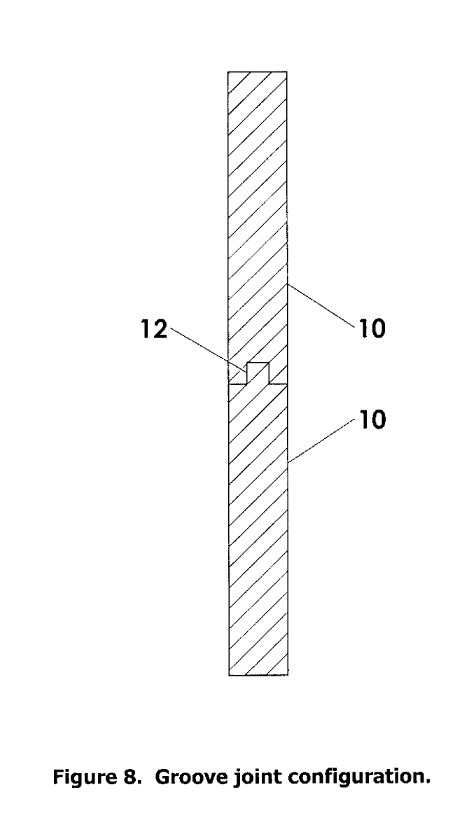

Combinations of silicon carbide 1, mullite 2 or tungsten 3 bodies to be joined with Makotite™ joining material require only a close fit with a thin layer of joining material, either as a slurry or dry powder, 12 between them. A close fit is defined as the opposing surfaces of the two bodies that are being joined having essentially the same shape so their surfaces essentially conform. The opposing surfaces do not have to be exactly the same shape. The joining material will fill any gap that may exist between the opposing surfaces. The joint gap spacing can range from 2 microns to 150 microns, but stronger joints are attained in the range of 10 microns to 50 microns. The assembly is joined by heating the Makotite™ joining material 12 until it reaches a liquid phase. Many tube assembly geometries are possible, including, but not limited to, those of FIGS. 1-10.

Makotite™ 12 is used for both ceramic to ceramic and ceramic to metal joints between silicon carbide, mullite or tungsten and silicon carbide, mullite or tungsten. Makotite™ is a mixed oxide material developed and produced by FM Technologies, Inc. Makotite™ has various formulations which are comprised of a combination of alumina (Al2O3), silica (SiO2) and magnesia (MgO), with or without additions of less than 4 wt % collectively of TiO2, Fe2O3, CaO, NaO2, K2O, P2O5 and/or any other binder or sintering aid used in the art. Makotite™ can also be made with the addition of a single or multi-modal silicon carbide powder for improved strength. The multi-modal powder is composed of a mixture of two or more silicon carbide particle sizes from sub-micron to many microns.

In accordance with the embodiment of the invention, although other binders and sintering aids can be used as is previously done in the art, there is Makotite™ joining material that can be used for joining of silicon carbide, mullite or tungsten to silicon carbide, mullite or tungsten in the following ranges of composition grouped A through L, where the column 1 in each composition group, e.g. Al, Bl, Cl, etc., represents the preferred weight percent (wt % or percent by mass) ratio of constituents:

| | Group A | | | | | |
|---|---|---|---|---|---|---|
| | Composition Range | | | | | |
| | A1 | A2 | A3 | A4 | A5 | A6 |
| wt % Lava* | 60.00 | 30.00 | 40.00 | 50.00 | 70.00 | 80.00 |
| wt % Steatite† | 40.00 | 70.00 | 60.00 | 50.00 | 30.00 | 20.00 |
| Total | 100.00 | 100.00 | 100.00 | 100.00 | 100.00 | 100.00 |

*Lava is also known as either aluminum-silicate or Wonder Stone
†Steatite is also known as magnesium-silicate

| | Group B | | | | | |
|---|---|---|---|---|---|---|
| | Composition Range | | | | | |
| | B1 | B2 | B3 | B4 | B5 | B6 |
| wt % Al₂O₃ | 28.24 | 16.81 | 20.64 | 24.45 | 32.03 | 35.79 |
| wt % SiO₂ | 59.19 | 61.16 | 60.50 | 59.85 | 58.53 | 57.89 |
| wt % MgO | 12.57 | 22.03 | 18.86 | 15.70 | 9.44 | 6.32 |
| Total | 100.00 | 100.00 | 100.00 | 100.00 | 100.00 | 100.00 |

| | Group C | | | | | |
|---|---|---|---|---|---|---|
| | Composition Range | | | | | |
| | C1 | C2 | C3 | C4 | C5 | C6 |
| wt % Al₂O₃ | 27.14 | 16.07 | 19.76 | 23.45 | 30.83 | 34.52 |
| wt % SiO₂ | 56.87 | 58.43 | 57.92 | 57.40 | 56.35 | 55.84 |
| wt % MgO | 12.08 | 21.04 | 18.05 | 15.06 | 9.09 | 6.10 |
| wt % TiO₂ | 1.78 | 1.39 | 1.52 | 1.65 | 1.91 | 2.04 |
| wt % Fe₂O₃ | 0.85 | 0.93 | 0.90 | 0.88 | 0.83 | 0.80 |
| wt % CaO | 0.48 | 0.74 | 0.65 | 0.56 | 0.39 | 0.30 |
| wt % NaO₂ | 0.40 | 0.70 | 0.60 | 0.50 | 0.30 | 0.20 |
| wt % K₂O | 0.40 | 0.70 | 0.60 | 0.50 | 0.30 | 0.20 |
| Total | 100.00 | 100.0 | 100.00 | 100.00 | 100.00 | 100.00 |

| | Group D | | | | | |
|---|---|---|---|---|---|---|
| | Composition Range | | | | | |
| | D1 | D2 | D3 | D4 | D5 | D6 |
| wt % Steatite | 40.00 | 70.00 | 60.00 | 50.00 | 30.00 | 20.00 |
| wt % | 60.00 | 30.00 | 40.00 | 50.00 | 70.00 | 80.00 |
| Mulcoa^{‡} 47 | | | | | | |
| Total | 100.00 | 100.00 | 100.00 | 100.00 | 100.00 | 100.00 |

^{‡}Mulcoa is a registered trade name for alumina silica calcines

| | Group E | | | | | |
|---|---|---|---|---|---|---|
| | Composition Range | | | | | |
| | E1 | E2 | E3 | E4 | E5 | E6 |
| wt % Steatite | 50.00 | 80.00 | 70.00 | 60.00 | 40.00 | 30.00 |
| wt % Mulcoa | 50.00 | 20.00 | 30.00 | 40.00 | 60.00 | 70.00 |
| 60 | | | | | | |
| Total | 100.00 | 100.00 | 100.00 | 100.00 | 100.00 | 100.00 |

| | Group F | | | | | |
|---|---|---|---|---|---|---|
| | Composition Range | | | | | |
| | F1 | F2 | F3 | F4 | F5 | F6 |
| wt % Steatite | 60.00 | 90.00 | 80.00 | 70.00 | 50.00 | 40.00 |
| wt % Mulcoa | 40.00 | 10.00 | 20.00 | 30.00 | 50.00 | 60.00 |
| 70 | | | | | | |
| Total | 100.00 | 100.00 | 100.00 | 100.00 | 100.00 | 100.00 |

| | Group G | | | | | |
|---|---|---|---|---|---|---|
| | Composition Range | | | | | |
| | G1 | G2 | G3 | G4 | G5 | G6 |
| wt % Al₂O₃ | 30.06 | 17.53 | 21.71 | 25.89 | 34.24 | 38.42 |
| wt % SiO₂ | 54.00 | 57.00 | 56.00 | 55.00 | 53.00 | 52.00 |
| wt % MgO | 13.13 | 21.57 | 18.76 | 15.95 | 10.32 | 7.51 |
| wt % TiO₂ | 0.97 | 0.99 | 0.98 | 0.98 | 0.97 | 0.96 |
| wt % Fe₂O₃ | 0.42 | 0.71 | 0.62 | 0.52 | 0.33 | 0.23 |
| wt % CaO | 0.45 | 0.72 | 0.63 | 0.54 | 0.36 | 0.26 |
| wt % NaO₂ | 0.45 | 0.73 | 0.64 | 0.55 | 0.36 | 0.27 |
| wt % K₂O | 0.45 | 0.73 | 0.64 | 0.55 | 0.36 | 0.27 |
| wt % P₂O₅ | 0.05 | 0.03 | 0.04 | 0.05 | 0.06 | 0.07 |
| Total | 100.00 | 100.00 | 100.00 | 100.00 | 100.00 | 100.00 |

| | Group H | | | | | |
|---|---|---|---|---|---|---|
| | Composition Range | | | | | |
| | H1 | H2 | H3 | H4 | H5 | H6 |
| wt % Al₂O₃ | 31.76 | 15.70 | 21.06 | 26.41 | 37.11 | 42.46 |
| wt % SiO₂ | 48.90 | 55.56 | 53.34 | 51.12 | 46.68 | 44.46 |
| wt % MgO | 16.11 | 24.44 | 21.66 | 18.88 | 13.33 | 10.55 |
| wt % TiO₂ | 1.07 | 1.03 | 1.04 | 1.05 | 1.08 | 1.09 |
| wt % Fe₂O₃ | 0.53 | 0.81 | 0.72 | 0.62 | 0.44 | 0.34 |
| wt % CaO | 0.54 | 0.81 | 0.72 | 0.63 | 0.44 | 0.35 |
| wt % NaO₂ | 0.54 | 0.81 | 0.72 | 0.63 | 0.44 | 0.35 |
| wt % K₂O | 0.52 | 0.81 | 0.71 | 0.62 | 0.42 | 0.33 |
| wt % P₂O₅ | 0.05 | 0.02 | 0.03 | 0.04 | 0.06 | 0.07 |
| Total | 100.00 | 100.00 | 100.00 | 100.00 | 100.00 | 100.00 |

| | Group I | | | | | |
|---|---|---|---|---|---|---|
| | Composition Range | | | | | |
| | I1 | I2 | I3 | I4 | I5 | I6 |
| wt % Al₂O₃ | 30.52 | 11.38 | 17.76 | 24.14 | 36.90 | 43.28 |
| wt % SiO₂ | 46.72 | 56.68 | 53.36 | 50.04 | 43.40 | 40.08 |
| wt % MgO | 19.13 | 27.28 | 24.56 | 21.85 | 16.41 | 13.69 |
| wt % TiO₂ | 1.09 | 1.02 | 1.04 | 1.07 | 1.11 | 1.13 |
| wt % Fe₂O₃ | 0.62 | 0.91 | 0.81 | 0.72 | 0.53 | 0.44 |
| wt % CaO | 0.63 | 0.91 | 0.81 | 0.72 | 0.54 | 0.44 |
| wt % NaO₂ | 0.63 | 0.91 | 0.81 | 0.72 | 0.54 | 0.44 |
| wt % K₂O | 0.62 | 0.91 | 0.81 | 0.72 | 0.53 | 0.43 |
| wt % P₂O₅ | 0.04 | 0.01 | 0.02 | 0.03 | 0.06 | 0.07 |
| Total | 100.00 | 100.00 | 100.00 | 100.00 | 100.00 | 100.00 |

| | Group J | | | | | |
|---|---|---|---|---|---|---|
| | Composition Range | | | | | |
| | J1 | J2 | J3 | J4 | J5 | J6 |
| wt % Al₂O₃ | 25.14 | 12.57 | 16.76 | 20.95 | 29.33 | 33.52 |
| wt % SiO₂ | 32.88 | 16.44 | 21.92 | 27.40 | 38.36 | 43.84 |
| wt % MgO | 0.08 | 0.04 | 0.05 | 0.06 | 0.09 | 0.10 |
| wt % TiO₂ | 1.38 | 0.69 | 0.92 | 1.15 | 1.61 | 1.84 |
| wt % Fe₂O₃ | 0.45 | 0.23 | 0.30 | 0.38 | 0.53 | 0.60 |
| wt % CaO | 0.08 | 0.04 | 0.05 | 0.06 | 0.09 | 0.10 |
| wt % Steatite | 40.00 | 70.00 | 60.00 | 50.00 | 30.00 | 20.00 |
| Total | 100.00 | 100.00 | 100.00 | 100.00 | 100.00 | 100.00 |

| | Group K | | | | | |
|---|---|---|---|---|---|---|
| | Composition Range | | | | | |
| | K1 | K2 | K3 | K4 | K5 | K6 |
| wt % Al₂O₃ | 18.49 | 9.24 | 12.32 | 15.41 | 21.57 | 24.65 |
| wt % SiO₂ | 37.36 | 18.68 | 24.90 | 31.13 | 43.58 | 49.81 |
| wt % MgO | 0.32 | 0.16 | 0.21 | 0.27 | 0.37 | 0.42 |
| wt % TiO₂ | 0.91 | 0.45 | 0.60 | 0.76 | 1.06 | 1.21 |
| wt % Fe₂O₃ | 1.88 | 0.94 | 1.25 | 1.57 | 2.19 | 2.50 |
| wt % CaO | 0.07 | 0.03 | 0.04 | 0.06 | 0.08 | 0.09 |
| wt % NaO₂ | 0.16 | 0.08 | 0.11 | 0.14 | 0.19 | 0.22 |
| wt % K₂O | 0.74 | 0.37 | 0.49 | 0.62 | 0.86 | 0.98 |
| wt % P₂O₅ | 0.09 | 0.05 | 0.06 | 0.08 | 0.11 | 0.12 |
| wt % Steatite | 40.00 | 70.00 | 60.00 | 50.00 | 30.00 | 20.00 |
| Total | 100.00 | 100.00 | 100.00 | 100.00 | 100.00 | 100.00 |

| | Group L | | | | | |
|---|---|---|---|---|---|---|
| | Composition Range | | | | | |
| | L1 | L2 | L3 | L4 | L5 | L6 |
| wt % Al₂O₃ | 2.00 | 3.50 | 3.00 | 2.50 | 1.50 | 1.00 |
| wt % SiO₂ | 24.00 | 42.00 | 36.00 | 30.00 | 18.00 | 12.00 |
| wt % MgO | 12.00 | 21.00 | 18.00 | 15.00 | 9.00 | 6.00 |
| wt % TiO₂ | 0.40 | 0.70 | 0.60 | 0.50 | 0.30 | 0.20 |
| wt % Fe₂O₃ | 0.40 | 0.70 | 0.60 | 0.50 | 0.30 | 0.20 |
| wt % CaO | 0.40 | 0.70 | 0.60 | 0.50 | 0.30 | 0.20 |
| wt % NaO₂ | 0.40 | 0.70 | 0.60 | 0.50 | 0.30 | 0.20 |
| wt % K₂O | 0.40 | 0.70 | 0.60 | 0.50 | 0.30 | 0.20 |
| wt % Lava | 60.00 | 30.00 | 40.00 | 50.00 | 70.00 | 80.00 |
| Total | 100.00 | 100.00 | 100.00 | 100.00 | 100.00 | 100.00 |

Composition Group B is a simplified version of composition Group A that has all additives removed aside from the three highest percentage constituents of Group A; those three constituents being alumina, silica and magnesia. This results in a Makotite™ formulation with a greater than 200° C. higher softening point, giving a higher allowable service temperature and greater strength at higher temperatures. A special case of composition Group B that specifically varies the magnesia content, and balances the alumina and silica accordingly to maintain a constant coefficient of thermal expansion throughout the composition group, is presented below that is classified as composition Group P:

| Group P Composition | P0 | P3 | P6 | P9 |
|---|---|---|---|---|
| wt % Al₂O₃ | 28.24 | 47.05 | 41.15 | 35.25 |
| wt % SiO₂ | 59.19 | 49.95 | 52.85 | 55.75 |
| wt % MgO | 12.57 | 3.00 | 6.00 | 9.00 |
| Total | 100.00 | 100.00 | 100.00 | 100.00 |

Although various Makotite™ formulations can be produced, there are two formulation that are preferred for ceramic to ceramic and ceramic to metal joints between silicon carbide, mullite or tungsten and silicon carbide, mullite or tungsten. The first formulation involves a mixture of between 30 wt % and 80 wt %, nominally 60 wt %, aluminum-silicate, also known as Lava or Wonder Stone, and between 20 wt % and 70 wt %, nominally 40 wt %, magnesium-silicate, also known as Steatite. The aluminum-silicate and magnesium-silicate are mixed in powder form to a 100% weight fraction to form Makotite™. The second formulation involves a mixture of between 16.8 wt % (weight percent or percent by mass) and 35.8 wt %, nominally 28.2 wt %, alumina, between 57.9 wt % (weight percent or percent by mass) and 61.2 wt %, nominally 59.2 wt %, silica and between 6.3 wt % and 22.0 wt %, nominally 12.6 wt %, magnesia. The alumina, silica and magnesia are mixed in powder form to a 100% weight fraction to form Makotite™. When mixing powders, any particle size from 150 microns down to nanometer scale particles, or combination thereof, are acceptable for the constituent materials of any Makotite™ formulation.

The powders can be used as is in this basic mixture, but it is preferable to mill the powder mixture using a planetary ball mill for between 4 and 20 hours. Once prepared, the Makotite™ joining material is applied as a slurry or dry powder that covers the surfaces being joined, or is provided a path to do so from a reservoir once it has a reached a liquid phase, with a volume of joining material that is greater than or equal to the volume of empty space present between the surfaces to be joined when assembled prior to application of the joining material. If a slurry is the desired form of application, the slurry is created by mixing the prepared Makotite™ powder with a volatile liquid binder such as water or alcohol, preferably ethanol, that is allowed to evaporate as the joint assembly is slowly heated. Once sufficient joining material has been applied in and/or around the joint area, fixturing is applied to hold the coupled parts together prior to heating. The type and level of fixturing is dependent on the size and configuration of parts to be joined. Examples of fixturing used are gravity, if the parts overlap and are able stand in a stable manner once assembled, or graphite sleeves that are shaped to match the parts and removed after joining is complete or, in the case of long parts greater than 0.5 m in length, gripping the parts outside of the heating area using something such as a Wilson seals (a type of demountable mechanical O-ring seal) that act to hold the assembly together. Once parts are assembled and fixed, the joint is heated, either radiantly or using microwaves or any other source of heating, and in either vacuum or an inert gas atmosphere, to between 1400° C. and 1600° C. for the aluminum-silicate/magnesium-silicate formulation or to between 1550° C. and 1750° C. for the alumina/silica/magnesia formulation, to allow the joining material to achieve a liquid phase. Once heated, the joint is held at temperature for between 1 minute and 5 minutes to allow the joining material to spread evenly within the joint area. The joint is then allowed to cool to room temperature, and is ready to either be joined to other ceramic or metal parts or be used as part of a furnace coil assembly.

Using this described Makotite™ joining material, every ceramic to ceramic and ceramic to metal joint is helium leak tight to less than 1×10-9 torr.-L./sec. helium leak rate, and oxidation resistant, with service temperature from 400-1000° C. for the ceramic to metal joints and 1100-1500° C. for ceramic to ceramic joints. All Makotite™ formulations work equally well for silicon carbide to silicon carbide, silicon carbide to mullite, silicon carbide to tungsten, mullite to mullite, mullite to tungsten and tungsten to tungsten joints. The various formulations exist to either get higher strength at higher temperature, such as with the Group B and Group P composition ranges or when silicon carbide powder is added, or to simplify the mix and allow the joining to be performed in a lower temperature furnace, such as with the Group A composition range. The joints have strengths comparable to the as received materials at room temperature. For ceramic to ceramic joints, flexural strength is 334 MPa and shear strength is 241 MPa. For ceramic to metal joints, shear strength is greater than 308 MPa.

### EXAMPLES

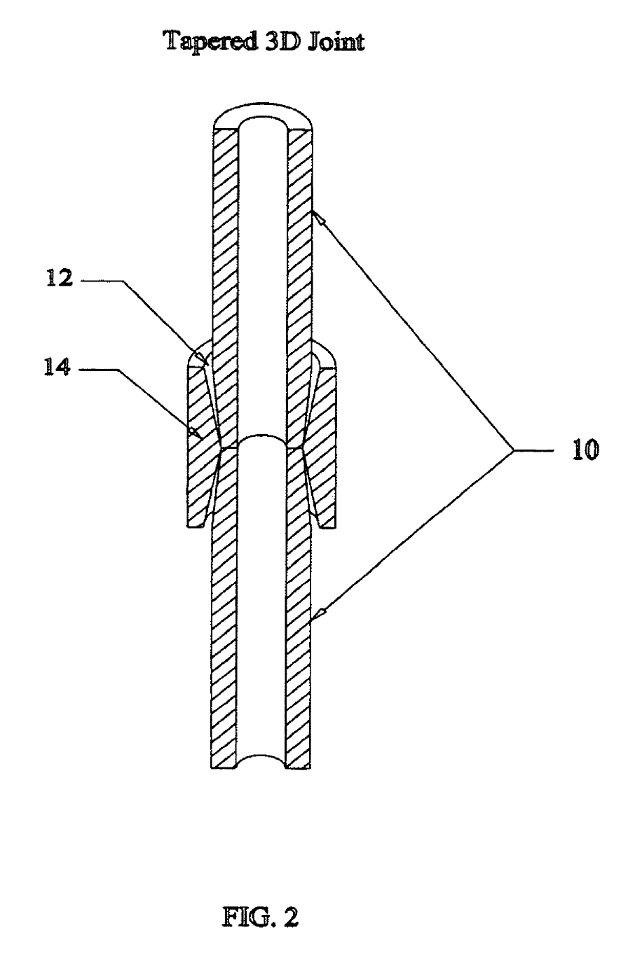

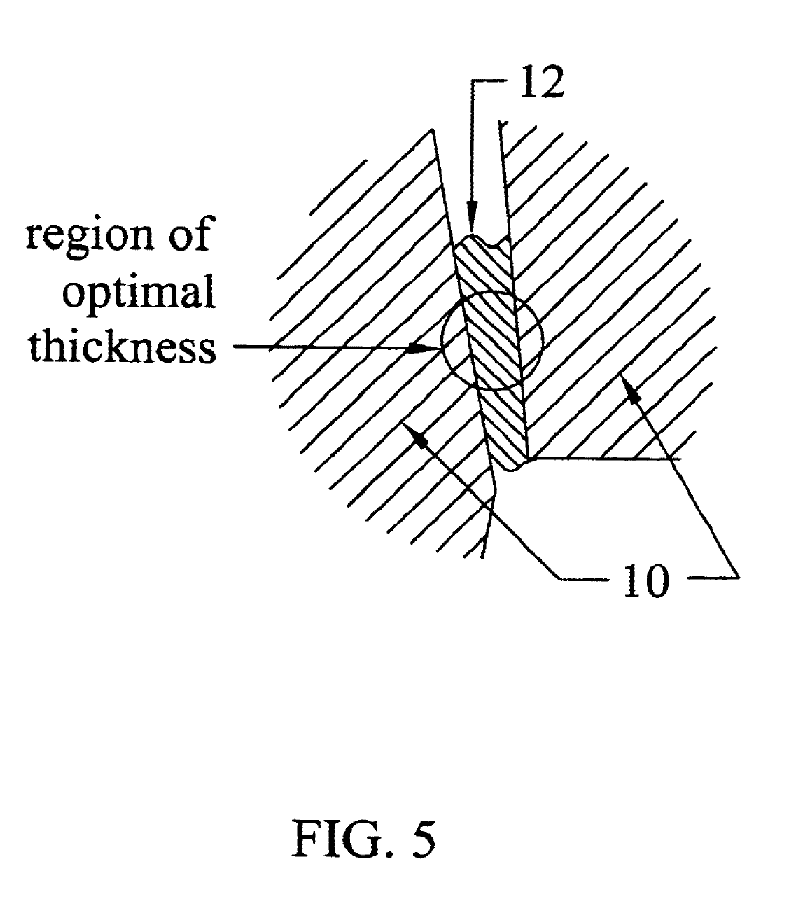

FIGS. 1-10 display a variety of joint configurations. Silicon carbide, mullite or tungsten to silicon carbide, mullite or tungsten butt joints, sleeve joints, step joints, taper joints, groove joints and plug joints have all been made using Makotite™ joining material. All of these joint configurations are helium leak tight. In FIG. 5, the joint was deliberately shown with a wide gap for viewing the joint. Note that the joint gap can be made with nearly zero thickness. To make a joint with both an alignment and capture geometry, as shown in FIG. 2, the collar 14 is machined with an inner taper that is 0.5-10 degrees halfway through on both ends of the collar 14 and the tubes 10 are machined with outer tapers that are 0-9.5 degree at the ends that are intended to be joined. The tube 10 tapers are always smaller than the collar tapers. The outer tapers at the tube 10 ends go as deep as one inner taper on the collar 14 that was machined halfway through. When the tube 10 ends are joined to the collar 14, the tapers provide alignment during heating and also a reservoir for bonding slurry 12. Because of the shallower taper angle on the tube ends compared to the collar 14, there is a volume between the tapers that acts as reservoir for the bonding slurry 12. The strongest joint will form in the region where the gap spacing is between 10 to 50 microns.

### Example 1

For this example, 50 g of Makotite™ joining material from the Group B1/P0 composition is prepared by mixing 14.120 g alumina powder of 500 mesh grain size, 7.595 g silica powder of 500 mesh grain size and 6.285 g magnesia powder of 500 mesh grain size. The mixed Makotite™ powder is placed in a 100 mL alumina ceramic grinding jar with 100 6 mm diameter alumina ceramic grinding balls and 16 10 mm diameter alumina ceramic grinding balls. The jar is then sealed, loaded into a planetary ball mill and allowed to mill for 8 hours. Once ball milling is completed, the Makotite™ powder is removed from the jar and separated from the alumina grinding balls using a sieve.

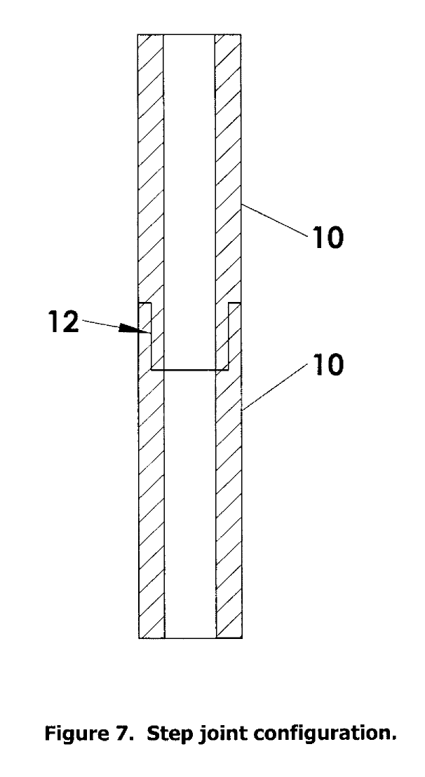

Two silicon carbide tubes measuring 2.375 in. OD×2 in. ID×6 in. long are prepared for joining by machining using diamond based abrasive grinding bits such that one tube has a male step and the other a female step of 0.5 in length, as shown in FIG. 7, with a gap of 0.0015 in between the OD of the male step and the ID of the female step.

A slurry is then created by mixing 5 g of the milled and sieved Makotite™ powder with ethanol until a viscosity similar to that of paint is achieved, approximately 10 cP. The slurry is applied between the faces of the steps to be joined 12. Once a layer of slurry of 0.010 in thickness has been applied in and around the joint area, the female tube is inserted into the male tube and the excess joining material from the radial faces is allowed to collect between the butting faces of the tubes. Graphite fixturing is applied such as to provide a stable base, allowing the assembly to stand vertically, as shown in FIG. 7, and a 50 g weight to be placed on top of the assembly to prevent the joint from opening once the joining material has reached a liquid phase upon heating. Once parts are assembled and fixed, the joint assembly is heated radiantly in vacuum to 1050° C. at 5° C. per minute, at which point 1 atmosphere of argon is vented into the furnace. It is preferable to begin the process in vacuum to assist in removing any excess water vapor, unwanted organics, or any other volatiles that may have been introduced in the preparation process. Once in argon, the joint assembly is further heat to 1725° C. at 5° C. per minute to allow the joining material to achieve a liquid phase, and held at 1725° C. for 3 minutes to allow the joining material to spread evenly within the joint area. An atmosphere of argon, or another inert gas, is necessary above 1400° C. to prevent excessive vaporization of SiO2 from the joining material. The joint assembly is then allowed to cool to room temperature at 5° C. per minute to complete the joining process.

### Example 2

For this example, 50 g of Makotite™ joining material from the Group Al composition is prepared by mixing 30 g aluminum-silicate powder of 2500 mesh grain size and 20 g magnesium-silicate powder of 325 mesh grain size. The mixed Makotite™ powder is placed in a 100 mL alumina ceramic grinding jar with 100 6 mm diameter alumina ceramic grinding balls and 16 10 mm diameter alumina ceramic grinding balls. The jar is then sealed, loaded into a planetary ball mill and allowed to mill for 6 hours. Once ball milling is completed, the Makotite™ powder is removed from the jar and separated from the alumina grinding balls using a sieve.

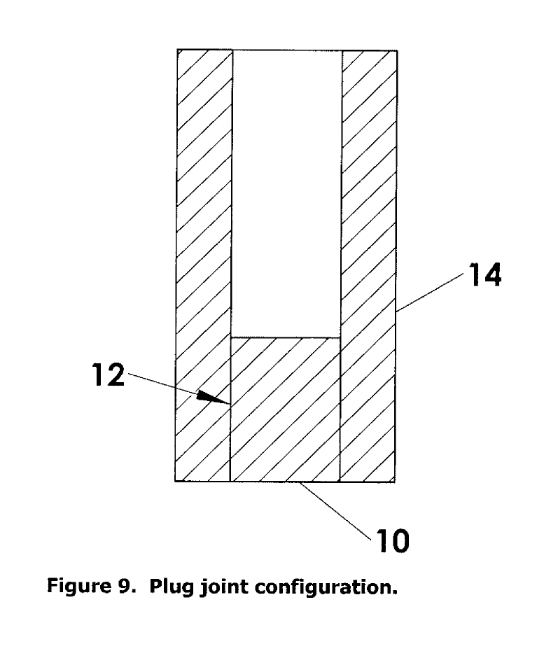

A 1.25 in. OD×0.946 in. ID×3 in. long tungsten tube and a 1 in. OD×0.5 in long silicon carbide plug are prepared for joining by machining using diamond based abrasive grinding bits such that the tungsten tube has a 3° ID taper at one end that opens to a 1 in. ID at the mouth of the tube and the silicon carbide plug has a 3° OD taper along its entire length that such that one end or the plug retains its original 1 in. OD. When assembled as shown in FIG. 9, this will result in a 0.0016 in. gap for joining material to flow and fill between the OD of the silicon carbide plug and the ID of the tungsten taper.

A slurry is then created by mixing 5 g of the milled and sieved Makotite™ powder with ethanol until a viscosity similar to that of paint is achieved, approximately 10 cP. The slurry is applied on the ID of the tapered portion of the tungsten tube and the OD of the silicon plug 12. Once a layer of slurry of 0.010 in thickness has been applied in and around the joint area, the silicon carbide plug is inserted into the tapered end of the tungsten and the excess joining material from the radial faces is allowed to collect on the face of the silicon carbide plug that is inside the tungsten tube. Excess powder from the outward face of the silicon carbide plug is wiped off using an alcohol wipe. The prepared joint assembly is placed on a boron nitride (h-BN) base such that it stands vertically, as shown in FIG. 9, allowing the tungsten to act as a weight at the top of the assembly to prevent the joint from opening once the joining material has reached a liquid phase upon heating. Once parts are assembled and fixed, the joint assembly is heated radiantly in vacuum to 1200° C. at 5° C. per minute, at which point one atmosphere of argon is vented into the furnace. It is preferable to begin the process in vacuum to assist in removing any excess water vapor, unwanted organics, or any other volatiles that may have been introduced in the preparation process. Once in argon, the joint assembly is further heat to 1540° C. at 5° C. per minute to allow the joining material to achieve a liquid phase, and held at 1540° C. for 3 minutes to allow the joining material to spread evenly within the joint area. The joint is then allowed to cool to room temperature at 5° C. per minute to complete the joining process.

### Example 3

For this example, 55 g of Makotite™ joining material from the Group Al composition is prepared, with the addition of silicon carbide powder for improved strength, by mixing 30 g aluminum-silicate powder of 2500 mesh grain size, 20 g magnesium-silicate powder of 2500 mesh grain size and 5 g silicon carbide powder of 325 mesh grain size. The mixed Makotite™ powder is placed in a 100 mL alumina ceramic grinding jar with 100 6 mm diameter alumina ceramic grinding balls and 16 10 mm diameter alumina ceramic grinding balls. The jar is then sealed, loaded into a planetary ball mill and allowed to mill for 4 hours. Once ball milling is completed, the Makotite™ powder is removed from the jar and separated from the alumina grinding balls using a sieve.

Two silicon carbide tubes measuring 2.375 in. OD×2 in. ID×6 in. long are prepared for joining by machining using diamond based abrasive grinding bits such that one tube has a male step and the other a female step of 0.5 in length, as shown in FIG. 7, with a gap of 0.0015 in between the OD of the male step and the ID of the female step.

A slurry is then created by mixing 5 g of the milled and sieved Makotite™ powder with ethanol until a viscosity similar to that of paint is achieved, approximately 10 cP. The slurry is applied between the faces of the steps to be joined 12. Once a layer of slurry of 0.010 in thickness has been applied in and around the joint area, the female tube is inserted into the male tube and the excess joining material from the radial faces is allowed to collect between the butting faces of the tubes. Graphite fixturing is applied such as to provide a stable base, allowing the assembly to stand vertically, as shown in FIG. 7, and a 50 g weight to be placed on top of the assembly to prevent the joint from opening once the joining material has reached a liquid phase upon heating. Once parts are assembled and fixed, the joint assembly is heated radiantly in vacuum to 1200° C. at 5° C. per minute, at which point one atmosphere of argon is vented into the furnace. It is preferable to begin the process in vacuum to assist in removing any excess water vapor, unwanted organics, or any other volatiles that may have been introduced in the preparation process. Once in argon, the joint assembly is further heat to 1540° C. at 5° C. per minute to allow the joining material to achieve a liquid phase, and held at 1540° C. for 5 minutes to allow the joining material to spread evenly within the joint area. The joint assembly is then allowed to cool to room temperature at 5° C. per minute to complete the joining process.

### Example 4

For this example, 50 g of Makotite™ joining material from the Group Al composition is prepared by mixing 30 g aluminum-silicate powder of 2500 mesh grain size and 20 g magnesium-silicate powder of 325 mesh grain size. The mixed Makotite™ powder is placed in a 100 mL alumina ceramic grinding jar with 100 6 mm diameter alumina ceramic grinding balls and 16 10 mm diameter alumina ceramic grinding balls. The jar is then sealed, loaded into a planetary ball mill and allowed to mill for 6 hours. Once ball milling is completed, the Makotite™ powder is removed from the jar and separated from the alumina grinding balls using a sieve.

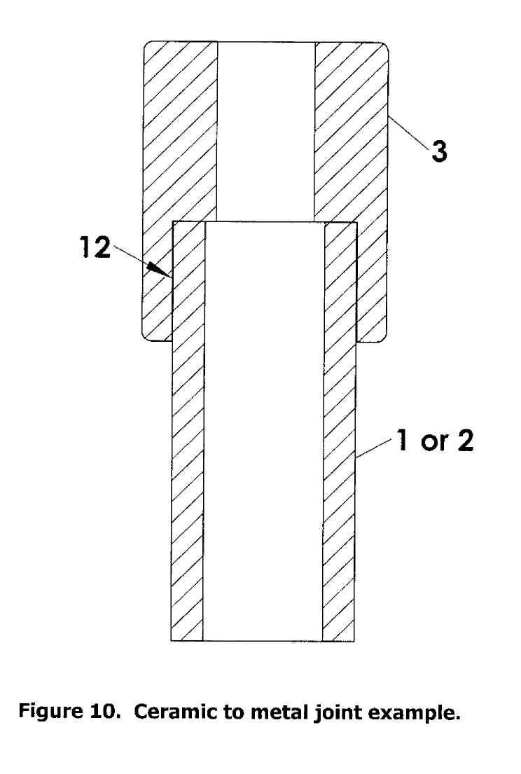

A 1.00 in. OD×0.40 in. ID×1.25 in. long tungsten tube and a 0.755 in. OD×0.50 in ID×1.75 in. long silicon carbide tube are prepared for joining by machining using diamond based abrasive grinding bits. The silicon carbide tube is machined to a 0.750 in. OD and a 0.753 in. diameter counterbore is machined into the tungsten tube to a depth of 0.50 in. at one end. When assembled as shown in FIG. 10, this will result in a 0.0015 in. gap for joining material to flow and fill between the OD of the silicon carbide tube and the ID of the tungsten counterbore.

A slurry is then created by mixing 5 g of the milled and sieved Makotite™ powder with ethanol until a viscosity similar to that of paint is achieved, approximately 10 cP. The slurry is applied on the ID of the counterbored portion of the tungsten tube and the over a 0.5 in. length of the OD of the silicon tube 12. Once a layer of slurry of 0.010 in thickness has been applied in and around the joint area, the silicon carbide tube is inserted into the counterbore of the tungsten tube and the excess joining material from the radial faces is allowed to collect on the face of the silicon carbide tube that is inside the tungsten tube. Excess powder from the exposed face of the silicon carbide tube is wiped off using an alcohol wipe. The prepared joint assembly is placed on a boron nitride base such that it stands vertically as shown in FIG. 10, allowing the tungsten to act as a weight at the top of the assembly to prevent the joint from opening once the joining material has reached a liquid phase upon heating. Once parts are assembled and fixed, the joint assembly is heated radiantly in vacuum to 1200° C. at 5° C. per minute, at which point one atmosphere of argon is vented into the furnace. It is preferable to begin the process in vacuum to assist in removing any excess water vapor, unwanted organics, or any other volatiles that may have been introduced in the preparation process. Once in argon, the joint assembly is further heat to 1540° C. at 5° C. per minute to allow the joining material to achieve a liquid phase, and held at 1540° C. for 3 minutes to allow the joining material to spread evenly within the joint area. The joint is then allowed to cool to room temperature at 5° C. per minute to complete the joining process. This completed assembly can now be joined to conventional metals such as stainless steels or superalloys using tungsten as a transitional coupling material from ceramic to conventional metal. Tungsten is used a coupling for 2 main reasons. First, the tungsten acts as a grading material that manages the stresses that result from the CTE mismatch of the low CTE ceramic and the high CTE conventional metal. Second, the tungsten acts as a barrier between the ceramic and the conventional metal, isolating the chemistry and preventing undesirable eutectics, specifically between silicon and nickel or iron, at temperatures below the desired service or joining temperatures.

REFERENCES, all of which are incorporated by reference herein.
[1] T. J. Clark, M. J. Hanagan, R. W. Cruse, K. Park, V. A. Szalai, S. J. Rohman, R. M. Mininni, U. S. Pat. No. 5,208,069 May 4, 1993 and EP0540084 B1 Sep. 4, 1996.
[2] F. M. Mako, R. Silberglitt, L. K. Len, Pulsed Electron Beam Joining of Materials, (Israel) Pat. No. 118126/2 (Oct. 3, 1994).
[3] F. M. Mako, R. Silberglitt, L. K. Len, Pulsed Electron Beam Joining of Materials, U. S. Pat. No. 5,599,468 (Feb. 4, 1997).
[4] F. M. Mako, R. L. Bruce, Ceramic Joining, U.S. Pat. No. 6,692,597 B2 (Feb. 17, 2004).
[5] F. M. Mako, R. L. Bruce, Ceramic Joining, PRC (China) Pat. No. ZL02824111.8 (Jun. 11, 2008).
[6] F. M. Mako, R. L. Bruce, Ceramic Joining, U.S. Pat. No. 8,337,648 B2 (Dec. 25, 2012).

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A high strength joint material consisting essentially of alumina (99.8% purity), silica (99.99% purity) and magnesia (99+% purity) with or without additions collectively of less than 4 wt % of TiO2, Fe2O3, CaO, NaO2, K2O, P2O5 and sintering aid materials.

2. The high strength joint material of claim 1, further comprising a mixed oxide material selected from the group consisting of Magnesium Silicate and Aluminum Silicate.

3. The high strength joint material of claim 1, further comprising a mixed oxide material selected from the group consisting of Steatite® and Mulcoa®.

4. The high strength joint material of claim 1, further comprising a mixed oxide material selected from the group consisting of Steatite® and Lava.

5. The high strength joint material of claim 1, further comprising a mixed oxide material selected from the group consisting of Steatite® and Wonder Stone®.

6. The high strength joint material of claim 1, wherein the joint material provides oxidation resistance at a temperature between 400° C. and 1500° C.

7. The high strength joint material of claim 1, wherein the joint material joins one of ceramic-to-ceramic, ceramic-to-metal and metal-to-metal.

8. The high strength joint material of claim 1, wherein the joint material has a coefficient of thermal expansion between 1.5×10-6/K and 5×10-6/K at a room temperature.

9. The high strength joint material of claim 1, wherein the joint material forms a hermetic joint between similar or dissimilar materials when the similar or dissimilar materials to be joined have a coefficient of thermal expansion between 1.5×10-6/K and 5×10-6/K, wherein the hermetic joint is defined by an ability to seal to less than 1×10-9 torr.-L./sec. helium leak rate.

10. The high strength joint material of claim 9, wherein the hermetic joint between the dissimilar materials with a coefficient of thermal expansion mismatch when each of the dissimilar materials to be joined has a coefficient of thermal expansion between 1.5×10-5/K and 5×10-6/K.

11. A material for a joint between a ceramic body and a metal body comprising:
between 30 wt % (weight percent or percent by mass) and 80 wt %, nominally 60 wt %, aluminum-silicate, and between 20 wt % and 70 wt %, nominally 40 wt %, magnesium-silicate.

12. A material for a joint between a ceramic body and a metal body comprising:
between 16.8 wt % and 35.8 wt %, nominally 28.2 wt %, alumina, between 57.9 wt % and 61.2 wt %, nominally 59.2 wt %, silica and between 6.3 wt % and 22.0 wt %, nominally 12.6 wt %, magnesia.

13. A material for a joint between a ceramic body and a ceramic body comprising:
between 30 wt % (weight percent or percent by mass) and 80 wt %, nominally 60 wt %, aluminum-silicate, and between 20 wt % and 70 wt %, magnesium-silicate.

14. A material for a joint between a ceramic body and a ceramic body comprising:
between 16.8 wt % and 35.8 wt % alumina, between 57.9 wt % and 61.2 wt % silica and between 6.3 wt % and 22.0 wt % magnesia.

15. A material for a joint between a ceramic body and a metal body comprising:
between 28.2 wt % and 47.1 wt %, nominally 28.24 wt %, alumina, between 49.9 wt % and 59.2 wt %, nominally 59.19 wt %, silica and between 3.0 wt % and 12.6 wt %, nominally 12.57 wt %, magnesia.

16. A material for a joint between a ceramic body and a metal body comprising:
between 28.2 wt % and 47.1 wt % alumina, between 49.9 wt % and 59.2 wt % silica and between 3.0 wt % and 12.6 wt % magnesia.
